(19) United States
(12) Patent Application Publication
(10) Pub. No.: US 2012/0275018 A1
(43) Pub. Date: Nov. 1, 2012

(54) COATED GLASSES HAVING A LOW SOLAR FACTOR

(75) Inventors: Songwei Lu, Wexford, PA (US); Larry J. Shelestak, Bairdford, PA (US); James P. Thiel, Pittsburgh, PA (US)

(73) Assignee: PPG INDUSTRIES OHIO, INC., Cleveland, OH (US)

(21) Appl. No.: 13/097,758

(22) Filed: Apr. 29, 2011

(51) Int. Cl. G02B 5/28; G02B 5/20

(52) U.S. Cl. 359/360; 359/359

(57) ABSTRACT

A glass transparency for an automotive roof window includes a solar control coating on a surface of a glass substrate to provide the coated glass with a solar factor in the range of equal to or less 30%, and an Lta in the range of greater than 0% to less than 50%. The solar factor is determined in accordance with ISO 13837 (2008). In another embodiment of the invention, the transparency is a laminated transparency having the solar control coating between two glass sheets.

### BACKGROUND OF THE INVENTION

1. Field of the Invention

This invention relates to coated glasses having a low solar factor, and more particularly, to vehicle windows, e.g. automotive roof windows having coated glass transparencies having a solar factor equal to or less than 30% calculated in accordance to the International Organization for Standardization (“ISO”) No. 13837 (2008).

2. Discussion of the Technical Challenge

There is continued interest in reducing the load applied to vehicle engines, e.g. automotive gasoline engines to increase the miles per gallon of fuel and to reduce the carbon monoxide exhausted from the engines. Of particular interest in the present discussion are the imposed and proposed regulations of the Federal Clean Air Act and of the California Air Resources Board (“CARB”) directed to vehicle windows, and in particular, directed to automotive roof windows to reduce solar energy passing through the windows to reduce solar heating of the vehicle interior. As is appreciated by those skilled in the art, reducing solar heating of the vehicle interior, especially during the summer months reduces the air conditioner load on the engine. One such regulation is directed to the automotive roof window and requires that the roof window have a solar factor of a specified value determined according to International Organization for Standardization (“ISO”) No. 13837 (2008). As is appreciated by those skilled in the art, the automotive roof window can be securely mounted in the roof, or can be moveably mounted in the roof. As is known in the art, automotive roof windows are also referred to as sun windows and moon windows.

The solar factor is a measure of the percent of solar energy or heat that passes through the window, e.g. the transparency of the roof window into the car interior. The lower the solar factor, the higher the solar protection, and the higher the performance of the transparency of the roof window. Using a solar control transparency can reduce the need for air-conditioning, thereby reducing air pollution and increasing miles per gallon of fuel.

The formula for calculating the solar factor recited in ISO No. 13837 (2008) includes the following variables: total solar energy transmission of the transparency; total solar energy reflectance of the transparency; total solar energy absorbance of the transparency, emissivity of the surfaces of the transparency facing the interior and exterior of the vehicle, speed of the wind moving over the exterior surface of the transparency, thickness of the transparency and heat transfer coefficient of the interior and the exterior surfaces of the transparency. A government, state or municipal agency selects the value of the solar factor. By way of illustration and of interest to the present discussion, CARB has selected a solar factor for transparencies for roof windows of equal to or less than 30%.

As can be appreciated by those skilled in the art, it would be commercially advantageous to provide transparencies, e.g. coated glass substrates for vehicle roof windows that meet the solar factor requirement set by the government, state and municipal agencies.

### SUMMARY OF THE INVENTION

This invention relates to a vehicle window including, among other things, a glass transparency, the glass transparency including, among other things, a glass substrate having a coated glass surface, and an opposite uncoated glass surface, and at a reference thickness of in the range of 3.6-4.1 millimeters has an Lta in the range of greater than 0% and equal to or less than 50%, and a solar factor of equal to or less than 30% determined according to International Standard Organization (“ISO”) 13837 (2008) using a substrate thickness of 4.0 millimeters; a wind speed of 4 meters per second; the uncoated glass surface having an emissivity of 0.84; a heat transfer coefficient of the uncoated surface of the substrate of 21 watts/square meter Kelvin, and heat transfer of the coated surface of the substrate of 8 watts/square meter Kelvin.

Further, this invention relates to a vehicle including, among other things, a roof window, wherein the roof window includes, among other things, a glass transparency. The transparency includes, among other things, a glass substrate having a coated glass surface, and an opposite uncoated glass surface, and at a reference thickness of 4 millimeters has an Lta in the range of greater than 0% and equal to or less than 50%, and a solar factor of equal to or less than 30% determined according to International Standard Organization (“ISO”) 13837 (2008) using a substrate thickness of 4.0 millimeters; a wind speed of 4 meters per second; the uncoated glass surface having an emissivity of 0.84; a heat transfer coefficient of the uncoated surface of the substrate of 21 watts/square meter Kelvin, and heat transfer of the coated surface of the coated surface of 8 watts/square meter Kelvin. Still further, this invention relates to a coated glass substrate including, among other things, a glass sheet and a coating on a surface of the glass sheet, wherein the glass sheet is a soda-lime-silicate glass substrate comprising the glass sheet is a soda-lime-silicate glass sheet having a glass portion including, among other things:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
   a colorant portion including, among other things:
total iron as Fe₂O₃ 1.00-2.2 weight percent
FeO at least 0.20 weight percent
Se 0.0005-0.005 weight percent
CoO 0.010-0.030 weight percent
redox ratio 0.22-0.28, and
   the coating is a pyrolytic coating including, among other things, oxides of group A and Group B, wherein Group A includes, among other things, oxides of iron, chromium and cobalt, and Group B includes, among other things, oxides of iron, chromium, cobalt, and manganese.

### BRIEF DESCRIPTION OF THE DRAWINGS

FIG. 1 is plan view of an automobile having a roof window incorporating features of the invention.

FIG. 2 is an isometric view of a non-limiting embodiment of a solar control transparency incorporating features of the invention.

FIG. 3 is an elevated side view of a non-limiting embodiment of a solar control transparency of Example 1 incorporating features of the invention.

FIG. 4 is a view similar to the view of FIG. 3 showing a non-limiting embodiment of a solar control transparency of Examples 2 and 3 incorporating features of the invention.

FIG. 5 is a view similar to the view of FIG. 3 showing a non-limited embodiment of a coated transparency assembly of Examples 4-6 incorporating features of the invention.

FIG. 6 is a view similar to the view of FIG. 2 showing a non-limited embodiment of a solar control laminated transparency of Examples 5 and 6 of the invention made using the solar control transparency assembly of FIG. 5.

FIG. 7 is a view similar to the view of FIG. 3 showing a non-limiting embodiment of a solar control transparency assembly of Examples 7 and 8 incorporating features of the invention.

FIG. 8 is a view similar to the view of FIG. 2 showing a non-limited embodiment of a solar control laminated transparency of Examples 7 and 8 of the invention made using the solar control transparency assembly of FIG. 7.

### DETAILED DESCRIPTION OF THE INVENTION

As used herein, unless otherwise expressly specified, all numbers such as those expressing values, ranges, amounts or percentages are read as if prefaced by the word “about”, even if the term does not expressly appear. When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Also, as used herein, the term “applied over”, and “deposited over” means applied, and deposited, on but not necessarily in surface contact with. For example, one surface, article, film or component “applied over”, and “deposited over” another surface, article, film or component of an article or apparatus does not preclude the presence of materials between the surfaces of the articles, or between components of the article or apparatus, respectively.

Before discussing non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise, in the following discussion like numbers refer to like elements.

In the following discussion, the non-limiting embodiments of the invention are directed to an automobile roof window having a coated glass transparency; the invention, however, is not limited thereto. More particularly, the coated transparency can be a part of a window for any type of land, air, space, on the water and under the water vehicle; of any residential or commercial window, and of windows for residential and commercial doors, oven doors and see through refrigerator doors. In addition, the automotive window is not limited to a roof window but can be a vehicle back or side window. Still further, the roof window is not limited to any particular design and any of the stationary and moveable roof window designs can be used in the practice of the invention.

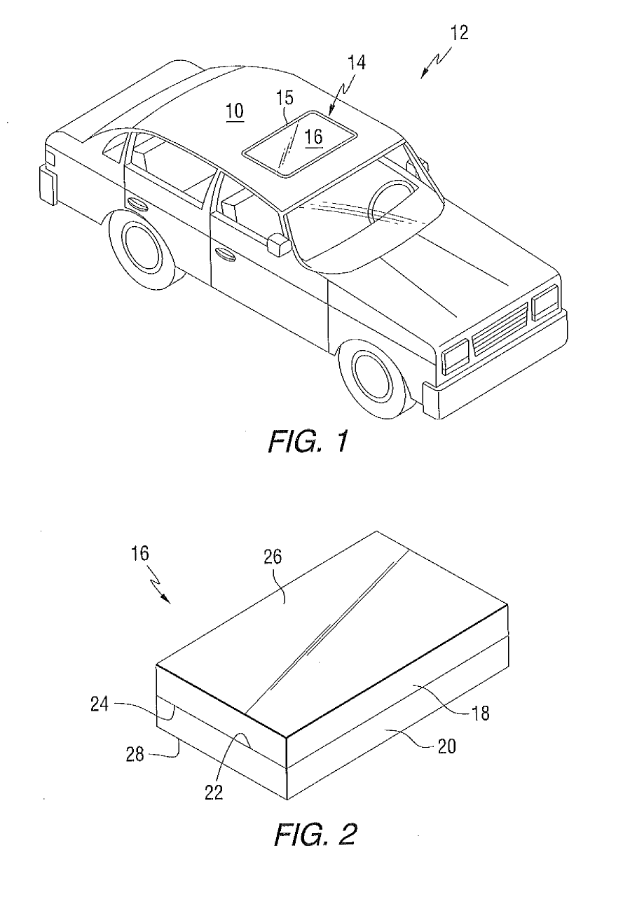

With reference to FIGS. 1 and 2 as needed, roof 10 of automobile 12 has a roof window 14 that includes a mounting frame 15 (shown only in FIG. 1) and a transparency 16 (FIG. 2). In the preferred practice of the invention, but not limited thereto, the transparency 16 includes a glass substrate 18 and a solar control coating 20. Surface 22 of the coating 20 is applied over, or on surface 24 of the glass substrate 18. Surface 26 of the glass substrate 18 opposite to the surface 24 of the glass substrate 18 and opposite to the surface 28 of the coating 20 faces the automobile exterior, and surface 28 of the coating 20 opposite to the surface 22 of the coating 20 and opposite to surface 26 of the glass substrate 18 faces the automobile interior. The transparency 16 can be securely mounted in the roof 10 for no movement, or mounted in the roof 10 for reciprocating movement between a closed position and an open position. For a discussion of securing a window in a vehicle roof for no movement, reference can be made to U.S. Patent Publication No. U.S. 2007/0079564A1, and for a discussion of a window moveably mounted in a vehicle roof, reference can be made to U.S. Patent Publication No. U.S. 2008/0081148A1, which documents in their entirety, are hereby incorporated by reference.

At the present time, the solar factor for roof windows proposed by CARB is not adopted and is not mandatory; nevertheless, for a full appreciation of the non-limiting embodiments of the invention, glass transparencies meeting the solar factor for roof windows proposed by CARB will be discussed. In a preferred, non-limiting embodiment, of the invention, the transparency 16 is mounted in the roof 10 of the automobile 12 with the uncoated surface 26 of the transparency 16 facing the exterior of the automobile 12, and the surface 28 of the coating 20 facing the interior of the vehicle. The solar factor of the transparency 16 is equal to or less than 30% calculated pursuant to ISO No. 13837 (2008), which document in its entirety is hereby incorporated by reference. Properties of the transparency 16 that are used to determine the solar factor include the following: total solar energy transmission (hereinafter also referred to as “TSET”) of the transparency 16; total solar energy reflectance (hereinafter also referred to as “TSER’) of the transparency 16; total solar energy absorbance (hereinafter also referred to as “TSEA”) of the glass transparency 16; emissivity of the exterior surface 26 of the substrate 18, and of the interior surface 28 of the coating 22, of the transparency 16 (see FIG. 2), speed of the wind moving over the exterior surface 26 of the substrate 18 of the transparency 16, thickness of the transparency 16, and heat transfer coefficient of the exterior surface 26 of the substrate 18, and of the interior surface 28 of the coating 22, of the transparency 16.

For purposes of discussion and not limiting to the invention, unless indicated otherwise, the emissivity of the exterior surface 26 of the substrate 18 (hereinafter also referred to as the exterior surface 26 of the transparency 16) is 0.84, which is the emissivity of glass. The emissivity of the interior surface 28 of the coating 20 (hereinafter also referred to as the interior surface 28 of the transparency 16) is measured pursuant to ASTM E 1585-93 (NFRC 301-93) tiled “Method for Measuring and Calculating Emittance of Architectural Flat Glass Products using Spectrophotometric Measurements”.

The wind speed over the exterior surface 26 of the transparency 16 is 4 meters per second, which is the wind speed when the vehicle is at rest as recited in ISO 13837 (2008). At 4 meters per second, the heat transfer coefficient of the exterior surface 20 of the substrate 18 of the transparency 16 is 21 watts/square meter Kelvin, and the heat transfer of the interior surface 28 of the coating 22 of the transparency 16 is 8 watts/square meter Kelvin.

The thickness of the transparency 16 (thickness of the substrate 18 and coating 22) is in the range of 3.6-4.1 millimeters (“mm”). In the following discussions of the properties of the non-limiting embodiments of the transparencies of the invention, the referenced thickness unless indicated otherwise is 4.00 mm; however, the properties of the non-limiting embodiments of the coated glass substrates of the invention can be found in the thickness range of 3.6-4.1 mm. As can be appreciated the invention is not limited to the values set forth above for emissivity, wind speed, thickness and heat transfer coefficients, and are presented with the values of TSET, TSER, TSEA to determine the solar factor to define the performance of the transparencies of the invention.

The TSET, TSER and TSEA are measured over the wavelength range of 300 to 2500 nanometers (“nm”) at a transparency 16 thickness of 4.00 mm unless indicated otherwise. For purposes of clarity, the ultraviolet wavelength range is less than 380 nm, the visible wavelength range is in the range of equal to or greater than 380 nm to less than 780 nm, and the infrared wavelength range is equal to or greater than 780 nm. As can be appreciated by those skilled in the art TSET, TSER and TSEA can be measured, or two of the group measured and the third calculated from one of the following equations (1)-(3):

TSET=100%−TSER−TSEA; (1)

TSER=100%−TSEA−TSET; (2)

TSEA=100%−TSET−TSER, (3)

where TSET, TSER and TSEA are as defined herein, and the thickness of the transparency 16 at each measurement or calculated value are the same.

The invention contemplates measuring the TSET, TSER and TSEA of the transparency with the surface 26 of the glass substrate 18 of the transparency 16 facing the energy source. In the non-limiting embodiment of the invention under discussion, the TSET and the TSER of the transparency 16 are measured, and the TSEA calculated using equation (3) above.

TSET is the ratio or percent of total solar energy transmitted through the transparency 16 to the amount of total solar energy incident or falling on the exterior surface 26 of the substrate 18 of the transparency 16. The TSET data provided throughout this discussion is based on a transparency 16 thickness of 4.0 millimeters (“mm”) unless indicated otherwise. The total solar energy transmittance (TSET) represents a computed value based on measured transmittances in the wavelength range of from 300 to 2500 nm at 5 nm, 10 nm, and 50 nm intervals for the UV, visible and IR wavelength ranges. The transmittance data is calculated pursuant to SAE J 1796 (1995) using air mass 1.5 Global direct solar irradiance data and integrated using the trapezoidal rule, as is known in the art, e.g. as discussed in U.S. Pat. No. 5,393,593, which patent in its entirety is hereby incorporated by reference. In one non-limiting embodiment of the invention, the transparency 16 at a thickness of 4.0 mm preferably has a TSET of greater than 0% and equal to or less than 5%, and more preferably from 1% to 5%.

TSER is the ratio or percent of the amount of the total solar energy reflected away from the exterior surface 26 of the transparency 16 to the amount of total solar energy incident on the exterior surface 26 of the glass substrate 18 of the transparency 16. As is appreciated by those skilled in the art, TSER also includes the solar energy passing through the surface 26 of the transparency 16 and reflected from the surface 22 of the substrate 18, and the surfaces 24 and 28 of the coating 20, of the transparency 16 toward the surface 26 of the transparency. For a more detailed discussion of solar rays incident on transparent reflective surfaces, reference can be made to U.S. patent application Ser. No. 12/911,189 filed Oct. 25, 2010 in the name of Benjamin Kabagambe et al and titled “Electrocurtain Coating Process for Solar Mirrors”, which document in its entirety is hereby incorporated by reference.

In the practice of the invention the TSER of the transparency 16 unless indicated otherwise is measured over the wavelength range of 300 to 2500 nm of the electromagnetic scale at a transparency thickness of 4.0 mm. The reflectance data is calculated pursuant to SAE J (1995) using air mass 1.5 Global solar irradiance data and integrated using the trapezoidal rule, as is known in the art. In the practice of the invention, the transparency 16 at a thickness of 4.0 mm preferably has a TSER of greater than 20% and equal to or less than 30%, and more preferably from 25% to 30%.

TSEA is the ratio or percent of the amount of the total solar energy directly absorbed by the transparency 16 to the amount of total solar energy incident on the exterior surface 26 of the transparency 16. In the non-limiting embodiment of the invention under discussion, the TSET and TSER of the glass transparency 16 are measured as discussed above, or in any other usual manner, and the TSEA is calculated using equation (3) above. In the practice of the invention, the transparency 16 at a thickness of 4.0 mm preferably has a TSEA of greater than 60% and equal to or less than 80%, and more preferably from 60% to 70%.

Reducing the TSET reduces the transmission of solar energy through the transparency 16 into the automotive interior, which reduces the transmission of visible light and invisible light into the automotive interior and visa versa. Increasing the TSER increases the reflection of solar energy from the surface 26 of the transparency 16, which reduces the transmission of solar energy, e.g. visible light and invisible light through the transparency 16 into the automotive interior and visa versa. Increasing the TSEA decreases the transmission of solar energy, e.g. visible light and invisible light into the automotive interior and visa versa. As can be appreciated, increasing one of TSET, TSER and TSEA effects the remaining ones of TSET, TSER and TSEA in accordance to equations (1)-(3).

The reduction of invisible light, e.g. ultraviolet solar energy and infrared solar energy passing through the glass transparency into the automotive interior is acceptable; however, reduction of visible light into the automotive interior reduces the advantage of having a roof window 14 (see FIG. 1). Although not a required property of the glass transparency to determine the solar factor pursuant to ISO 13837, in the practice of the invention, the glass transparency 16 at a thickness of 4.00 mm, preferably has a luminous or visible light transmission [2 degree observer] (“Lta”) (C.I.E. illuminant A) of greater than 0% and equal to or less than 50%; and more preferably in one or more of the following ranges: greater than 0% to 40%; greater than 0% to 20%; greater than 5% to 40%; greater than 10% to 30%; greater than 10% to 2%.

It is noted that luminous transmittance [2 degree observer] (“Lta”) (C.I.E. illuminant A) is understood in the art, and is used herein in accordance with its known meaning. This term is also known as “Ill. A” visible transmittance and is in the wavelength range of equal to or greater than 380 to less than 780 nm, and its measurements are made in accordance with CIE Publication 15.2 (1986) and ASTM E308. The transmittance data provided throughout this disclosure, unless indicated other wise, is based on a glass thickness of 4.0 millimeters (0.1575 inch). Luminous transmittance (Lta) is measured using C.I.E. 1931 standard illuminant “A” over the wavelength range equal to or greater than 380 to less than 780 nanometers at 10 nanometer intervals.

### EXAMPLE 1

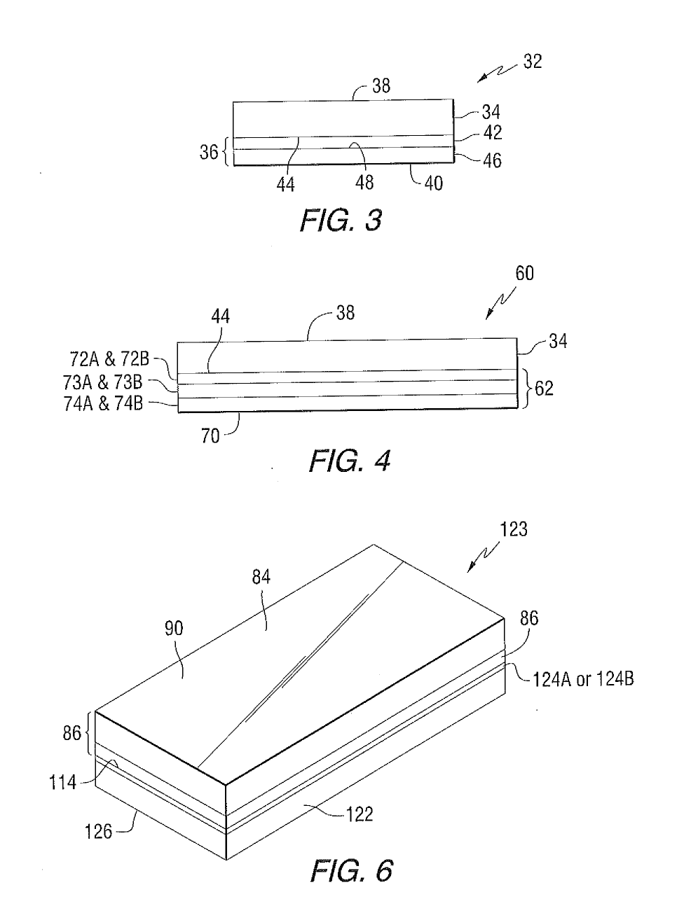

Glass transparency 32 shown in FIG. 3 is a non-limiting embodiment of the invention designated as Example 1. The transparency 32 includes a glass substrate 34 and a pyrolytically deposited solar control coating 36. Surface 38 of the glass substrate 34, or of the transparency 32 is designated to face the exterior of the automobile 12 (see FIG. 1), and surface 40 of the coating 36, or of the transparency 32 is designated to face the interior of the automobile.

The glass substrate 34 includes a soda lime silicate glass substrate having a glass base portion and a colorant portion. The glass base portion of the glass substrate 34 includes, but is not limited to:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
   the colorant portion includes, but is not limited to:
total iron as Fe₂O₃ 1.00-2.2 weight percent
FeO at least 0.20 weight percent
Se 0.0005-0.005 weight percent
CoO 0.010-0.030 weight percent
Redox ratio 0.22-0.28.

Any reference herein to composition amounts, such as “by weight percent”, “wt %” or “wt. %”, “parts per million” and “ppm” are based on the total weight of the final glass composition, or the total weight of the mixed ingredients, e.g. but not limited to the glass batch materials, which ever the case may be. The “total iron” content of the glass compositions disclosed herein is expressed in terms of Fe₂O₃ in accordance with standard analytical practice, regardless of the form actually present. Likewise, the amount of iron in the ferrous state (Fe++) is reported as FeO, even though it may not actually be present in the glass as FeO. The proportion of the total iron in the ferrous state is used as a measure of the redox state of the glass and is expressed as the ratio FeO/Fe₂O₃, which is the weight percent of iron in the ferrous state (expressed as FeO) divided by the weight percent of total iron (expressed as Fe₂O₃).

Glasses of the above type are sold by PPG Industries Inc. under the trademark GL-20. Additional details of the glass substrate 34 are disclosed in U.S. Pat. No. 5,393,593, which document in its entirety is hereby incorporated by reference.

The pyrolytic coating 36 is applied over or on the surface 44 of the glass substrate 34 to provide the transparency 32 with a solar factor of equal to or less than 30%. In the preferred practice of the invention, the pyrolytic coating 36 is of the type disclosed in U.S. Pat. No. 5,356,718 which document in its entirety is hereby incorporated by reference. In one non-limiting embodiment of the invention, the pyrolytic coating 36 has a thickness of 400 nanometers (“nm”) and includes a gradient layer of silica and tin oxide 42 having a thickness of 150 nm deposited on surface 44 of the glass substrate 34, and a tin oxide layer 46 having a thickness of 250 nm deposited over or on surface 48 of the gradient layer 42. At the surface 44 of the glass substrate 34, the gradient layer is 100% silica. As the thickness of the gradient layer 42 increases, the weight percent of silica decreases, and the weight percent of tin oxide increases. At the surface 48 of the gradient layer 42, i.e. the surface farthest from the surface 44 of the glass substrate 34, the gradient layer 42 is about 100% tin oxide. Although not limiting to the invention, a breaker layer (not shown) of the type disclosed in U.S. Pat. No. 6,797,388 can be provided between the gradient layer 42 and tin oxide layer 46 to inhibit crystal growth. The disclosure of U.S. Pat. No. 6,797,388 in its entirety is hereby incorporated by reference.

The solar factor for Example 1 is determined according to ISO 13837 (2008), using an emissivity of 0.84 for the exterior surface 38 of the glass substrate 34 of the transparency 32; a wind speed of 4 meters per second over the exterior surface 38; a heat transfer coefficient of 21 watts/square meter Kelvin for the exterior surface 38 of the substrate 34 of the transparency 32, and a heat transfer coefficient of 8 watts/square meter Kelvin for the interior surface 40 of the coating 36, of the transparency 32; a transparency thickness (thickness of the substrate 34 plus thickness of the coating 36) of 4.0 mm (0.1575 inch); a measured emissivity of the surface 40 of the transparency 32, a measured TSET, a measured TSER, and a calculated TSEA using Equation (3) above. The TSET and the TSER are measured with the surface 38 of the glass substrate 34 of the transparency 32 facing the energy source.

The thickness of the glass substrate 34 is 4.0 millimeters (“mm”), and the thickness of the transparency 32 is 4.0 mm. The coating 36 does not add any thickness because the mixed silicon and tin oxide film 42 has a thickness of 150 nm, and the tin oxide coating 46 has a thickness of 250 nm. The coating 36 has a thickness of 400 nm, which is equal to 0.0004 mm. As disclosed in U.S. Pat. No. 5,356,718, the pyrolytic coating 36 is applied to the air side of the glass ribbon. The tin side of the glass ribbon (the side of the glass ribbon supported on the metal bath during the coating process) is the exterior surface 38 of the transparency 32. The tin side of the glass ribbon is higher in reflectance in the wavelength range of 300-2500 nm than the air side, e.g. but not limiting to the discussion, the reflectance of the exterior surface 38 (the tin side) of the glass substrate 32 is 4.25%, and the reflectance of the interior surface 38 (the air side) of the glass substrate 32 is 4.00%. In general, coating the glass substrate with a coating having a refractive index higher than the refractive index of the glass substrate, the reflectance increases, and coating the glass substrate with a coating having a refractive index lower than the refractive index of the glass substrate, the reflectance decreases.

In the preferred practice of the invention, the glass substrate 34 had a thickness of 4.0 mm; the coating 36 had a mixed silicon and tin oxide film 42 having a thickness of 150 nm, and a tin oxide coating having a thickness of 250 nm; the surface 40 had a measured emissivity of 0.180; a measured Lta of 17.42%, a measured TSET of 13.92%, a measured TSER of 5.42%, a TSEA of 80.66% calculated using Equation 3, above, and a solar factor of 28.1% calculated in accordance to ISO 13837 (2008).

As is appreciated by those skilled in the art, a pyrolytic coating is a durable coating, and the surface 40 of the coating 36 faces the interior of the automobile 12 (see FIG. 1). In view of the forgoing, a protective cover sheet as discussed below over the surface 40 of the solar control coating 36 is not necessary and is therefore optional. Further as is appreciated by those skilled in the automotive window art, in the instance when the transparency 32 includes a single piece of glass, e.g. the glass substrate 34, the glass substrate 34 is annealed or heat strengthened in any convenient manner. In the preferred practice of the invention, the coating 36 is heat treatable, and the glass substrate 34 having the coating 36 can be heated treated.

### EXAMPLES 2 AND 3

Glass transparency 60 shown in FIG. 4 provides non-limiting embodiments of the invention designated as Examples 2 and 3. The glass transparency 60 includes the glass substrate 34 and a solar control coating 62. The surface 38 of the glass substrate 34 is designated to face the exterior of the automobile 12 (see FIG. 1), and surface 70 of the solar control coating 62 is designated to face the interior of the automobile 12. The solar factor of the transparency 60 for Examples 2 and 3 is determined according to ISO 13837 (2008), using an emissivity of 0.84 for the exterior surface 38 of the glass substrate 34 of the transparency 60; a wind speed of 4 meters per second over the exterior surface 38 of the glass substrate 34; a heat transfer coefficient of 21 watts/square meter Kelvin for the exterior surface 38 of the substrate 34 of the transparency 60, and a heat transfer coefficient of 8 watts/square meter Kelvin for the interior surface 70 of the coating 62, of the transparency 60; a transparency thickness (thickness of the substrate 32 plus thickness of the coating 62) of 4.0 mm (0.1575 inch); a measured emissivity for the interior surface 70, of the coating 62 of the transparency 60, a measured TSET, a measured TSER, and a calculated TSEA using Equation (3) above. The TSET and TSER are measured with the exterior surface 38 of the glass substrate 34 facing the energy source of the measuring instrument.

The glass substrate 34 of Example 1 is used in Examples 2 and 3. The solar control coating 62 in one non-limiting embodiment of the invention of Example 2 includes a titanium metal film 72A applied on or over the surface 44 of the glass substrate 34: a titanium nitride film 73A applied on or over the titanium film 72A, and a silicon nitride film 74A applied on or over the titanium nitride film 73A. The films 72A-74A are applied by magnetron sputtered vacuum deposition (MSVD). The coating 62 having the films 72A-74A is similar to the coating disclosed in U.S. Pat. No. 5,552,180, which patent in its entirety is incorporated herein by reference.

The coating 62 of Example 2 of the invention, includes, but is not limited to the titanium metal film 72A having a thickness in the range of 0.10 to 10 nm, preferably in the range of 0.10 to 1.0 nm, and most preferably in the range of 0.1 to 0.5 nm; the titanium nitride film 73A having a thickness in the range of 5 to 30 nm, preferably in the range of 10 to 25 nm and most preferably a thickness of 17 nm, and the silicon nitride film 74A having a thickness in the range of 30 to 150 nm, preferably in the range of 40 to 100 nm, and most preferably a thickness of 55 nm.

As is appreciated by those skilled in the art, windows having a single glass sheet, e.g. automotive side windows, rear windows and roof windows have the single glass sheet tempered or heat strengthened. The art of thermal tempering or heat strengthening is well known, e.g. see U.S. Pat. Nos. 4,444,579 and 5,118,335, which patent in its entirety is hereby incorporated by reference, and no further discussion is deemed necessary. In one non-limiting embodiment of Example 2 of the invention, the glass substrate 34 having the coating 62, i.e. the films 72A, 73A and 74A after tempering had a measured thickness of 4.0 nm, a coating 62 having a titanium film 72A converted to titanium oxide after tempering having a thickness of 2 nm, a titanium nitride film 73A having a thickness of 17 nm and a silicon nitride film 74A having a thickness of 55 nm. The surface 70 of the silicon film 74A, had an emissivity of 0.64. The tempered glass substrate 34 having the films 72A, 73A and 74A had a measured Lta of 9%, a measured TSET of 8.5%, a measured TSER of 6.0%; a TSEA of 85.5% calculated using Equation 3, above, and a solar factor of 29.5% calculated pursuant to ISO 13837 (2008).

Example 3 is similar to Example 2 except that the coating 62 includes the films 72B-74B. The film 72B is a titanium oxide film 72B applied on or over the surface 44 of the glass substrate 38; the film 73B is a titanium nitride film applied on or over the titanium oxide film 72B, and the film 74B is a silicon aluminum film 74B applied on or over the titanium nitride film 73B. The films 72B-74B are applied by magnetron sputtered vacuum deposition (MSVD). The coating 62 having the films 72B-74B The coating 62 having the films 72A-74A is similar to the coating disclosed in U.S. Pat. No. 5,552,180.

The coating 62 of Example 3 of the invention, includes, but is not limited to the titanium oxide film 72B having a thickness in the range of 0.1 to 20 nm, preferably in the range of 5 to 15, and most preferably a thickness of 10 nm. The titanium nitride film 73B preferably having a thickness in the range of 5 to 30 nm, more preferably in the range of 10 to 25 nm, and most preferably a thickness of 17 nm. The silica alumina film 74B preferably having thickness in the range of 15 to 120 nm, more preferably in the range of 30 to 90 and most preferably a thickness of 62.4. The silica alumina film 74B preferably includes silica in the range of 80-90 wt % and alumina in the range of 10-20 wt %, and preferably silica at 85 wt % and alumina at 15 wt %. A more detailed discussion of the silica alumina film 74B is presented in U.S. Patent Application Publication Nos. 2009/0258239A1; 2002/0172775A1; 2003/0228476A1; and U.S. Pat. Nos. 6,869,644; 7,311,961; 6,916,542 and 6,962,759, which documents in their entirety are hereby incorporated by reference.

In one non-limiting embodiment Example 3, the tempered solar control glass transparency 60 of Example 3 had a measured thickness of 3.96 mm, a coating 62 having a titanium oxide film 72B having a thickness of 1 nm, a titanium nitride film 73B having a thickness of 18 nm and a silica alumina film 74B having a thickness of 6.0 nm. The silica alumina film 74B included 85% silica and 15% of alumina. The surface 70 of the silica film 74B, had an emissivity of 0.64. The solar control transparency 60 of Example 3 had a measured Lta of 9.4%, a measured TSET of 6.2%, a measured TSER of 5.5%; a TSEA of 88.3% calculated using Equation 3, above, and a solar factor of 27.9% calculated pursuant to ISO 13837 (2008).

The coating 62 of Example 2 having the films 72A-74A provides an outer film 74A of silicon nitride which is a durable protective film, and the coating 62 of Example 3 having the films 72B-74B provides an outer film 74B of silica alumina which also is a durable protective film, and the surface 70 of the coating 62 having the films 72A-74A (Example 2) or 72B-74B (Example 3) faces the interior of the automobile 12 (see FIG. 1). In view of the forgoing, a protective cover sheet as discussed below over the surface 70 of the solar control coating 62 of the transparency 60 facing the automotive interior is not necessary and is therefore optional. Further as is appreciated by those skilled in the automotive window art, in the instance when the transparency 60 includes a single piece of glass, e.g. the glass substrate 34, the glass substrate 34, as discussed above having the coating 62 is heat treated to anneal or heat strengthen the glass in any convenient manner, In view of the forgoing, the films 72A-74A (Example 2) and 72B-74B (Example 3) are heat treatable coating films.

### EXAMPLES 4-6

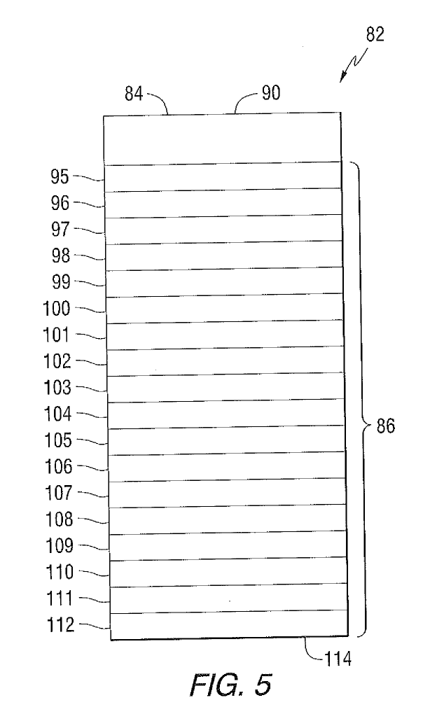

With reference to FIG. 5, non-limiting embodiments of the invention designated as Examples 4-6 each include a solar control transparency subassembly 82 incorporating features of the invention. The transparency subassembly 82 includes a glass substrate 84 and a solar control coating 86 having films 95-112. Surface 90 of the glass substrate 84 faces the exterior of the automobile 12 (see FIG. 1), and surface 114 of the solar control coating 86 faces the interior of the automobile.

The glass substrate 84 has a glass base portion and a colorant portion. In the preferred practice of the invention, the glass substrate 84 has a glass base portion that includes, but is not limited to:
SiO₂ 65-75 weight percent
Na₂O 10-20 weight percent
CaO 5-15 weight percent
MgO 0-5 weight percent
Al₂O₃ 0-5 weight percent
K₂O 0-5 weight percent
SO₃ 0-0.30 weight percent, and
   a colorant portion that includes, but is not limited to:
total iron as Fe₂O₃ greater than 0 to 0.120 weight percent, and
redox ratio less than 0.350.
   The glass substrate 84 is of the type sold by PPG Industries Inc. under the trademark Solarphire PV and is disclosed in U.S. Patent Application Publication No. 2010/0126218A1 published May 27, 2010, which document in its entirety is hereby incorporated by reference.

The glass substrate 84 has an Lta greater than 85%; a TSET value of greater than 85%; a TSER value of greater than 7%, and a TSEA of less than 2%.

In this non-limiting embodiment of the invention, the solar control coating 86 is an MSVD coating having three solar reflective films, e.g. but not limited to silver films to increase the TSIR. The coating 86 is similar to, but not limited to, the coating disclosed in U.S. Pat. No. 7,335,421, which patent in its entirety is hereby incorporated by reference. Table 1 below lists the composition, thickness, thickness range and reference number of each of the films 95-112 (see FIG. 5).

TABLE 1

| | | THICKNESS | |
|---|---|---|---|
| | THICKNESS | RANGE | REFERENCE |
| FILM | (angstroms) | (angstroms) | NUMBER (FIG. 5) |
| zinc stannate | 270 | 225-275 | 95 |
| zinc oxide | 148 | 125-175 | 96 |
| silver | 224 | 200-225 | 97 |
| titanium | 5 | 13-25 | 98 |
| zinc oxide | 115 | 100-125 | 99 |
| zinc stannate | 615 | 600-625 | 100 |
| zinc oxide | 115 | 100-125 | 101 |
| silver | 125 | 110-125 | 102 |
| titanium | 20 | 13-25 | 103 |
| zinc oxide | 101 | 85-105 | 104 |
| zinc stannate | 480 | 425-450 | 105 |
| zinc oxide | 101 | 85-105 | 106 |
| silver | 95 | 75-100 | 107 |
| titanium | 20 | 13-25 | 108 |
| zinc oxide | 200 | 70-85 | 109 |
| zinc stannate | 150 | 50-75 | 110 |
| (1) silica alumina | 490 | 400-550 | 111 |
| (2) silica alumina | 390 | 300-450 | 112 |

The zinc stannate films 95, 100, 105 and 110 preferably include zinc in the range of 30-50% and tin in the range of 50-70%. A more detailed discussion of zinc stannate films can be found in U.S. Pat. No. 4,610,771, which patent in its entirety is hereby incorporated by reference. The (1) silica alumina and the (2) silica alumina films are protective films of the type disclosed in U.S. Pat. No. 7,311,961, which patent in its entirety is hereby incorporated by reference. The (1) silica alumina film 111 had 40 wt % silica and 60 wt % alumina, and the (2) silica alumina film had 85 wt % silica and 15 wt % alumina.

In Example 4 of the invention, the glass transparency subassembly 82 is used alone and the solar factor is determined according to ISO 13837 (2008 ), using an emissivity of 0.84 for the exterior surface 90 of the glass substrate 84 of the transparency subassembly 82; a wind speed of 4 meters per second over the exterior surface 90 of the glass substrate 84 of the transparency subassembly 82; a heat transfer coefficient of 21 watts/square meter Kelvin for the exterior surface 90 of the substrate 84 of the transparent subassembly 82, and a heat transfer coefficient of 8 watts/square meter Kelvin for the interior surface 114 of the coating 86, of the transparent subassembly 82; a subassembly thickness (thickness of the substrate 84 plus thickness of the coating 86) of 4.0 mm (0.1575 inch); a measured emissivity of the surface 114 of the subassembly 82; a measured TSET and TSER, and a TSEA calculated using Equation (3) above. The TSET and TSER are measured with the exterior surface 90 of the glass substrate 84 facing the energy source of the measuring instrument.

The solar control glass transparency subassembly 82 of Example 4 had a solar factor greater than 30% because, among other things, the Lta was greater than 60%. The transparency subassembly 82 having a solar factor of greater than 30% does meet the CARB solar factor, however, the transparency subassembly 82 can be used when the solar factor is set at a value greater than 30%

As is appreciated by those skilled in the art, MSVD films of the type shown in TABLE 1, e.g. films 95-110 are not as durable as the coating 36 of Example 1 (FIG. 3); however, the protective films 74A and 74B (FIG. 4), and films 111 and 112 (FIG. 5), provide a protective coating for the underlying MSVD films. In regards to the subassembly 82 shown in FIG. 5, the solar factor is greater than 30% because of Lta is greater than 60%. In the practice of the invention, Examples 5 and 6 provide for a sheet 122, e.g. a glass sheet 122 to overlay the surface 114 of the subassembly 82 to provide a transparency 123 that has reduced Lta to provide the glass transparency 123 (FIG. 6) with a solar factor of equal to or less than 30%.

As can now be appreciated the invention is not limited to the composition of the protective glass sheet 122, provided the transparency 124 has a solar factor of equal to or less than 30% and preferably has an Lta of greater than 0%. In one non-limiting embodiment of the invention, the glass substrate 38 of Example 1 was used as the overlay sheet 122.

With reference to FIG. 6, Examples 5 and 6 of the invention each have the overlay sheet 122 laminated to the outer surface 114 of the coating 86 to provide a laminated solar control transparency 123. As is appreciated by those skilled in the art, the opening in the automotive roof for the roof window 14 is usually limited to a thickness of 5 mm. As such the thickness of the glass substrate 84 is reduced to compensate for the thickness of the overlay sheet 122, e.g. in one non-limiting embodiment of the invention, the glass substrate 84 had a thickness of 2.0 mm, the overlay sheet 122 had a thickness 0f 2.0 mm, and a polyvinyl butyral (“PVB”) sheet 124A or 124B had a thickness of 0.76 mm. Further, as can now be appreciated, the invention is not limited to the thickness of the glass sheets 84 and 122 and the thicknesses of the sheets can vary in the range of 1 to 3 mm. The PVB sheet 124A or 124B secures the protective sheet 122 to the surface 114 of the coating 86 to provide the laminated solar control transparency 123. The invention is not limited to the laminating process and any of the laminating processes used in the art, e.g. as disclosed in U.S. Pat. Nos. 4,820,902; 5,028,759, and 5,653,903 can be used in the practice of the invention to provide the laminated transparency 123 of the invention. The disclosures of U.S. Pat. Nos. 4,820,902; 5,028,759, and 5,653,903 in it entirety are hereby incorporated herein by reference.

In a non-limiting embodiment of Example 5 of the invention, the overlay sheet 122 was laminated to the surface 114 of the coating 86 by a 0.76 mm thick clear PVB sheet 124A having an Lta of 90%. In a non-limiting embodiment of Example 6 of the invention, the overlay sheet 124B was laminated to the surface 114 of the coating 86 by a 0.76 mm thick grey colored polyvinyl butyral sheet 124B having an Lta of 40%. The PVB sheets were of the type used in the automotive art to laminated sheets for windshields together.

The solar factor of the laminated transparency of Examples 5 and 6 was determined according to ISO 13837 (2008 ), using an emissivity of 0.84 for the exterior surface 90 of the glass substrate 84 of the transparency 123, and 0.84 for the outer surface 126 of the overlay sheet 122 of the laminated transparency 123; a wind speed of 4 meters per second over the exterior surface 90 of the glass substrate 84; a heat transfer coefficient of 21 watts/square meter Kelvin for the exterior surface 90 of the substrate 84 of the laminated transparency 123, and a heat transfer coefficient of 8 watts/square meter Kelvin for the interior surface 126 of the protective sheet 122 of the laminated transparency 123; a laminated transparency thickness of 4.80 mm (0.1895 inch) (the coated glass subassembly substrate 84 having a thickness of 2.04 mm; the PVB sheet 124A or 124B having a thickness of 0.76 mm and the overlay sheet having a thickness of 2.0 mm); a measured Lta; a measured TSET and TSER, and a TSEA calculated using Equation (3) above. The TSET and TSER are measured with the exterior surface 90 of the glass substrate 84 facing the energy source of the measuring instrument.

The laminated transparency 123 of Example 5 having the clear PVB had a measured Lta of 25.3%, a measured TSET of 11.2%, a measured TSER of 58.9%; a TSEA of 28.9%, and a solar factor of 19.4% calculated pursuant to ISO 13837 (2008 ).

The laminated transparency of Example 6 having the grey PVB had a measured Lta of 6.1%, a measured TSET of 3.3%, a measured TSER of 58.8%; a TSEA of 37.8%, and a solar factor of 13.7% calculated pursuant to ISO 13837 (2008 ).

### EXAMPLES 7 and 8

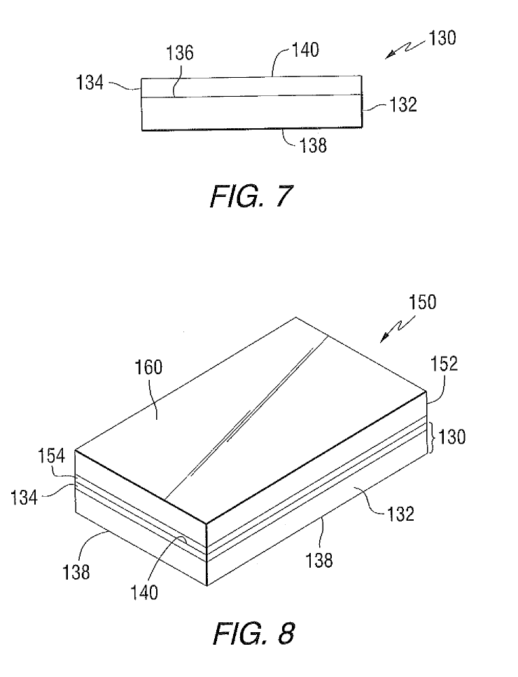

In the non-limiting embodiments of Examples 1-6 of the invention discussed above, the coatings 20 (FIG. 2), 36 (FIG. 3), 62 (FIG. 4) and 86 (FIG. 5) were designated to face the interior of the automobile. In Examples 7 and 8 of the invention, the solar control coating is a pyrolytic coating and is designated to face the exterior of the automobile 12 (FIG. 1). More particularly, and with reference to FIG. 7 there is shown a solar control transparency 130 having a glass substrate 132 and a solar control coating 134 on surface 136 of the glass substrate 132. Surface 138 of the glass substrate 132 opposite to the surface 136 of the substrate 132 is designated to face the interior of the automobile 12 (see FIG. 1) and surface 140 of the coating 134 is designated to face the exterior of the automobile 12.

In one non-limiting embodiment of Example 7, the glass substrate 132 is the glass substrate 34 of Example 1, and the pyrolytic solar control coating 134 is of the type disclosed in U.S. Pat. Nos. 3,660,061; 4,719,126 and 4,719,127, which documents in their entirety are hereby incorporated by reference. Examples of suitable coatings for use in Example 7 include, but are not limited to, a mixture of the oxides of iron, chromium and cobalt, and optionally manganese, produced pyrolytically from acetylacetonates (AcAc) of the metals in accordance with the process disclosed in U.S. Pat. No. 3,660,061 to Donley et al. Relatively water-insoluble coating reactants, such as acetylacetonates, can be physically suspended in an aqueous medium by continuous mixing as disclosed in U.S. Pat. No. 4,719,126 to Henery. Alternatively, such reactants are chemically suspended in an aqueous medium by utilizing very fine micron-sized particles of coating reactants in combination with a chemical wetting agent as disclosed in U.S. Pat. No. 4,719,127 to Greenberg. The resulting aqueous suspension can be applied by conventional means, typically spraying, to a heated glass substrate, preferably a float glass ribbon, e.g. as disclosed in U.S. Pat. No. 3,660,061 to Donley et al., which patent in its entirety is hereby incorporated by reference.

In one non-limiting embodiment of the invention, an aqueous solution of iron acetylacetonate and manganese acetylacetonate (ratio 1:1) was mixed and sprayed onto the surface 136 of the glass substrate 132 heated to a temperature of 1200° F. The glass substrate had a thickness of 4.1 mm, and the coating had a thickness in the range of 500 to 700 nm, and in particular 600 nm.

The solar factor of the glass transparency 130 of Example 7 is determined according to ISO 13837, using an emissivity of 0.84 for the interior surface 138 of the glass substrate 132, of the transparency 130; a wind speed of 4 meters per second over the exterior surface 140 of the coating 134, of the transparency 130; a heat transfer coefficient of 21 watts/square meter Kelvin for the exterior surface 140 of the coating 134, of the transparency 130 and a heat transfer coefficient of 8 watts/square meter Kelvin for the interior surface 138 of the glass substrate 132, of the transparency 130; a transparency thickness (thickness of the substrate 132 plus thickness of the coating 134) of 4.1 mm (0.1614 inch); a measured emissivity of 0.84 for the exterior surface 140 of the coating 134, a measured Lta of 9.0%, a measured TSET of 10.11%, a measured TSER of 21.94%, a TSEA of 67.95% calculated using Equation (3) above and a solar factor of 28.7% calculated pursuant to ISO 13837 (2008 ). The TSET and TSER are measured with the exterior surface 140 of the coating 134 of the transparency 130 facing the energy source of the measuring instrument.

Although not limiting to the invention, designating the surface 138 of the transparency 130 to face the exterior of the automobile and designating the surface 140 of the coating to face the interior of the automobile, the solar factor calculated pursuant to ISO 13837 (2008 ) was 33.6%.

As can be appreciated by those skilled in the art, even though the coating 134 of the assembly 130 is a pyrolytic coating and is a durable coating, it is designed to face the exterior of the automobile 12 and will be exposed to wind, dust, and scrapers to remove snow and ice. In view of the forgoing, Example 8 of the invention provides for laminating a protective sheet 152 to the surface 140 of the coating 134 of the transparency 130 to provide a solar control laminated transparency 150 of the invention shown in FIG. 8. The protective sheet 152 in one non-limiting embodiment of Example 8 of the invention is the glass substrate 84 (FIG. 6) of Examples 4-6. The protective sheet 152 is laminated to the surface 140 of the coating 134 of the assembly 130 by a PVB sheet 154. The PVB sheet can be the clear PVB sheet 124A, or the colored PVB sheet 124B. Preferably, the PVB sheet 154 (FIG. 8) is the grey or colored PVB sheet 124B (FIG. 6) to reduce the Lta.

With continued reference to FIG. 8, the laminated transparency 150 of Example 8 having a thickness of 4.81 mm is made up of the protective sheet 152 having a thickness of 1.94 mm and the substrate 138 having a thickness of 2.1 mm and the colored PVB sheet 154 having a thickness of 0.76 mm. The solar factor of the laminated transparency 150 of Example 8 is determined according to ISO 13837 (2008 ), using an emissivity of 0.837 for exterior surface 160 of the protective sheet 152 of the laminated transparency 150, and 0.837 for the interior surface 138 of the glass substrate 132 of the laminated transparency 150; a wind speed of 4 meters per second over the exterior surface 160 of the protective sheet 152; a heat transfer coefficient of 21 watts/square meter Kelvin for the exterior surface 160 of the protective sheet 152 of the laminated transparency 150, and a heat transfer coefficient of 8 watts/square meter Kelvin for the interior surface 138 of the glass substrate 132 of the laminated transparency 150; a measured TSET and TSER, and a TSEA calculated using Equation (3) above. The TSET and TSER are measured with the exterior surface 160 of the protective sheet 152 facing the energy source of the measuring instrument.

The solar factor of the laminated transparency 150 of Example 8 was not measured, however, it is expected that the laminated transparency 150 described above will have a solar factor of less than 30% and an Lta of less than 10%.

Another non-limiting embodiment of the invention is the transparency 130 shown in FIG. 7, which includes but is not limited to a coated glass sheet article having an Lta of less that 10%, e.g. as low as 7 to 8% at a coated glass thickness of 4.1 mm. More particularly, a 4.1 mm uncoated glass substrate 34 having the glass composition listed in Example 1 and provided below for convenience includes a soda lime silicate glass substrate having a glass base portion and a colorant portion. The glass base portion of the glass substrate 34 includes, but is not limited to:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
   the colorant portion includes, but is not limited to:
total iron as Fe₂O₃ 1.00-2.2 weight percent
FeO at least 0.20 weight percent
Se 0.0005-0.005 weight percent
CoO 0.010-0.030 weight percent
Redox ratio 0.22-0.28

Embodiments of the glass substrate 132, at a reference thickness of 4.1 millimeters, have an Lta in the range of 15% to less than 35%, a TSET in the range of 15% to 22%, a TSIR in the range of 11% to 20% and a TSEA of up to 70%. In the practice of the invention, the transparency 130 (the coated glass substrate) at a reference thickness of 4.1 millimeters, has an Lta in the range of greater than 0% to less than 15%, and preferably greater than 0% to equal to and less than 10%; a TSET in the range of greater than 0% to less than 12%; a TSIR in the range of greater than 0% to less than 11%, and preferably greater than 0% to equal to and less than 10% and a TSEA of greater than 70%, and preferably greater than 75%.

In this embodiment of the invention, transmittance reduction of the glass substrate 132 is provided by the metal oxide coating 134. In one non-limiting embodiment of the invention, a coating of an aqueous solution of iron acetylacetonate and manganese acetylacetonate (ratio 1:1) was mixed and sprayed onto the surface 136 of the glass substrate 132 heated to a temperature of 1200° F. The glass substrate had a thickness of 4.1 mm, and the coating had a thickness of 600 nm.

Table 2 below provides a comparison of the properties of the uncoated glass substrate 132 and the coated glass substrate, i.e. the transparency 130.

TABLE 2

| | | | | | | | R % | R % |
|---|---|---|---|---|---|---|---|---|
| | | | | ISO | | | coated | uncoated |
| transparency | Lta % | TSIR % | TSET % | UV % | a* (T) | b* (T) | side | side |
| coated glass | 9.0 | 9.89 | 9.65 | 1.26 | 2.056 | 5.278 | 27.45 | 4.31 |
| substrate | | | | | | | | |
| 130 | | | | | | | | |
| uncoated | 17.21 | 11.90 | 15.51 | 3.4 | 0.214 | 0.052 | 4.38 | 4.09 |
| glass | | | | | | | | |
| substrate | | | | | | | | |
| 132 | | | | | | | | |

From Table 2, it can now be appreciated that coating the glass substrate 132 changes the optical properties of the glass substrate 132. More particularly, the Lta is reduced to less than 10%.

While specific embodiments of the invention have been described in detail, it will be appreciated by those skilled in the art that various modifications and alternatives to those details can be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A vehicle window comprising a glass transparency, the glass transparency comprises a glass substrate having a coated glass surface, and an opposite uncoated glass surface, and at a reference thickness of in the range of 3.6-4.1 millimeters has an Lta in the range of greater than 0% and equal to or less than 50%, and a solar factor of equal to or less than 30% determined according to International Standard Organization (“ISO”) 13837 (2008 ) using a substrate thickness of 4.0 millimeters; a wind speed of 4 meters per second; the uncoated glass surface having an emissivity of 0.84; a heat transfer coefficient of the uncoated surface of the substrate of 21 watts/square meter Kelvin, and heat transfer of the coated surface of the substrate of 8 watts/square meter Kelvin.

2. The vehicle window according to claim 1 wherein total solar energy transmitted (TSET) and total solar energy reflected (TSER) is measured with the uncoated surface of the substrate facing an energy source of an instrument and the total solar energy absorbed (TSEA) is determined from the formula
TSEA=100%−the measured TSET−the measured TSER, wherein the TSET and the TSER are measured over a wavelength of 300-2500 nm of the electromagnetic spectrum.

3. The vehicle window according to claim 1 wherein total solar energy transmitted (TSET) and total solar energy reflected (TSER) is measured with the coated surface facing an energy source of an instrument and the total solar energy absorbed (TSEA) is determined from the formula
TSEA=100%−the measured TSET−the measured TSER, wherein the TSET and the TSER are measured over a wavelength of 300-2500 nm of the electromagnetic spectrum.

4. The vehicle window according to claim 1 wherein the coating is selected from the group of a pyrolytic applied coating and a magnetron sputtered vacuum deposited coating.

5. The vehicle window according to claim 4 wherein the coating is a fluorine doped tin oxide pyrolytic coating.

6. The vehicle window according to claim 1 comprising a glass sheet having a first uncoated surface and an opposite second uncoated surface, wherein the first surface of the glass sheet is laminated to the coating to define a laminated transparency, wherein first outer major surface of the laminated transparency is the uncoated surface of the substrate and second opposite major surface of the laminated transparency is the second surface of the glass sheet and each of the outer major surfaces of the transparency have an emissivity of 0.84.

7. The vehicle window according to claim 6 wherein total solar energy transmitted (TSET) and total solar energy reflected (TSER) is measured with the first major surface of the laminated transparency facing an energy source of an instrument and the total solar energy absorbed (TSEA) is determined from the formula
TSEA=100%−the measured TSET−the measured TSER, wherein the TSET and the TSER are measured over a wavelength of 300-2500 nm of the electromagnetic spectrum.

8. The vehicle window according to claim 6 wherein total solar energy transmitted (TSET) and total solar energy reflected (TSER) is measured with the second major surface of the transparency facing an energy source of a measuring instrument and the total solar energy absorbed (TSEA) is determined from the formula
TSEA=100%−the measured TSET−the measured TSER, wherein the TSET and the TSER are measured over a wavelength of 300-2500 nm of the electromagnetic spectrum.

9. The vehicle window according to claim 6, wherein the coating is a magnetron sputtered vacuum deposited coating and comprises at least two silver films and four dielectric films.

10. The vehicle window according to claim 9 wherein the substrate is a soda-lime-silicate glass substrate having a glass base portion comprising:
SiO₂ 65-75 weight percent
Na₂O 10-20 weight percent
CaO 5-15 weight percent
MgO 0-5 weight percent
Al₂O₃ 0-5 weight percent
K₂O 0-5 weight percent
SO₃ 0-0.30 weight percent, and
a colorant portion comprising:
total iron as Fe₂O₃ greater than 0 to 0.120 weight percent,
and a redox ratio less than 0.350, and
the glass sheet is a soda-lime-silicate glass sheet having a glass portion comprising:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
a colorant portion comprising:
total iron as Fe₂O₃ 1.00-2.2 weight percent
FeO at least 0.20 weight percent
Se 0.0005-0.005 weight percent
CoO 0.010-0.030 weight percent
redox ratio 0.22-0.28.

11. The vehicle window according to claim 6 wherein the substrate is a soda-lime-silicate glass substrate comprising the glass sheet is a soda-lime-silicate glass sheet having a glass portion comprising:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
a colorant portion comprising:
total iron as Fe₂O₃ 1.00-2.2 weight percent
FeO at least 0.20 weight percent
Se 0.0005-0.005 weight percent
CoO 0.010-0.030 weight percent
redox ratio 0.22-0.28, and
the glass sheet is a soda-lime-silicate glass sheet having a glass base portion comprising:
SiO₂ 65-75 weight percent
Na₂O 10-20 weight percent
CaO 5-15 weight percent
MgO 0-5 weight percent
Al₂O₃ 0-5 weight percent
K₂O 0-5 weight percent
SO₃ 0-0.30 weight percent, and
a colorant portion comprising:
total iron as Fe₂O₃ greater than 0 to 0.120 weight percent,
and a redox ratio less than 0.350.

12. The vehicle window according to claim 11 wherein the coating is a pyrolytic coating comprising oxides of group A and Group B, wherein Group A comprises oxides of iron, chromium and cobalt, and Group B comprises oxides of iron, chromium, cobalt, and manganese.

13. The vehicle window according to claim 1 wherein the transparency has a visible light transmission in the range of greater than 0 to 50%.

14. A vehicle comprising a roof window, wherein the roof window comprises a glass transparency, the transparency comprising:
a glass substrate having a coated glass surface, and an opposite uncoated glass surface, and at a reference thickness in the range of 3.9 to 4.1 millimeters has an Lta in the range of greater than 0% and equal to or less than 50%, and a solar factor of equal to or less than 30% determined according to International Standard Organization (“ISO”) 13837 (2008 ) using a substrate thickness of 4.0 millimeters; a wind speed of 4 meters per second; the uncoated glass surface having an emissivity of 0.84; a heat transfer coefficient of the uncoated surface of the substrate of 21 watts/square meter Kelvin, and heat transfer of the coated surface of the coated surface of 8 watts/square meter Kelvin.

15. The vehicle according to claim 14 wherein the coated surface of the glass substrate faces the interior of the vehicle, and the total solar energy transmitted (TSET) and total solar energy reflected (TSER) is measured with the uncoated surface of the substrate facing an energy source of an instrument and the total solar energy absorbed (TSEA) is determined from the formula
TSEA=100%−the measured TSET−the measured TSER, wherein the TSET and the TSER are measured over a wavelength of 300-2500 nm of the electromagnetic spectrum.

16. The vehicle according to claim 14 wherein the uncoated surface of the glass substrate faces the vehicle interior and total solar energy transmitted (TSET) and total solar energy reflected (TSER) is measured with the coated surface facing an energy source of an instrument and the total solar energy absorbed (TSEA) is determined from the formula
TSEA=100%−the measured TSET−the measured TSER, wherein the TSET and the TSER are measured over a wavelength of 300-2500 nm of the electromagnetic spectrum.

17. The vehicle according to claim 14 wherein the transparency comprises a glass sheet having a first uncoated surface and an opposite second uncoated surface, wherein the first surface of the glass sheet is laminated to the coating to define a laminated transparency, wherein first outer major surface of the laminated transparency is the uncoated surface of the substrate and second opposite major surface of the laminated transparency is the second surface of the glass sheet and each of the major surfaces of the transparency have an emissivity of 0.84.

18. The vehicle according to claim 17 wherein the substrate is a soda-lime-silicate glass substrate having a glass base portion comprising:
SiO₂ 65-75 weight percent
Na₂O 10-20 weight percent
CaO 5-15 weight percent
MgO 0-5 weight percent
Al₂O₃ 0-5 weight percent
K₂O 0-5 weight percent
SO₃ 0-0.30 weight percent, and
a colorant portion comprising:
total iron as Fe₂O₃ greater than 0 to 0.120 weight percent,
and a redox ratio less than 0.350, and
the glass sheet is a soda-lime-silicate glass sheet having a glass portion comprising:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
a colorant portion comprising:
total iron as Fe₂O₃ 1.00-2.2 weight percent
FeO at least 0.20 weight percent
Se 0.0005-0.005 weight percent
CoO 0.010-0.030 weight percent
redox ratio 0.22-0.28.

19. The vehicle according to claim 17 wherein the substrate is a soda-lime-silicate glass substrate comprising the glass sheet is a soda-lime-silicate glass sheet having a glass portion comprising:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
a colorant portion comprising:
total iron as Fe₂O₃ 1.00-2.2 weight percent
FeO at least 0.20 weight percent
Se 0.0005-0.005 weight percent
CoO 0.010-0.030 weight percent
redox ratio 0.22-0.28, and
the glass sheet is a soda-lime-silicate glass sheet having a glass base portion comprising:
SiO₂ 65-75 weight percent
Na₂O 10-20 weight percent
CaO 5-15 weight percent
MgO 0-5 weight percent
Al₂O₃ 0-5 weight percent
K₂O 0-5 weight percent SO₃ 0-0.30 weight percent, and
a colorant portion comprising:
total iron as Fe₂O₃ greater than 0 to 0.120 weight percent,
and a redox ratio less than 0.350.

20. A coated glass substrate comprising a glass sheet and a coating on a surface of the glass sheet, wherein the glass sheet is a soda-lime-silicate glass substrate comprising the glass sheet is a soda-lime-silicate glass sheet having a glass portion comprising:
SiO₂ 66-75 weight percent
Na₂O 10-20 weight percent
CaO 5-15 weight percent
MgO 0-5 weight percent
Al₂O₃ 0-5 weight percent
K₂O 0-3 weight percent
BaO 0-1 weight percent, and
a colorant portion comprising:
total iron as Fe₂O₃ 1.00-2.2 weight percent
FeO at least 0.20 weight percent
Se 0.0005-0.005 weight percent
CoO 0.010-0.030 weight percent
redox ratio 0.22-0.28, and
the coating is a pyrolytic coating comprising oxides of group A and Group B, wherein Group A comprises oxides of iron, chromium and cobalt, and Group B comprises oxides of iron, chromium, cobalt, and manganese.

21. The glass sheet according to claim 20 wherein the coated glass substrate at a reference thickness of 4 mm has an Lta in the range of greater than 0 to less than 50% Lta.
